(19) United States
(12) Patent Application Publication
(10) Pub. No.: US 2007/0065017 A1
(43) Pub. Date: Mar. 22, 2007

(54) Genetic family-tree object recognition

(75) Inventors: Ashwin Kotwaliwale, Sunnyvale, CA (US); Barry Winnett, Solihull (GB)

Correspondence Address: Raj Abhyanker, LLP;C/O PortfolioIP, P.O. Box 52050, Minneapolis, MN, 55402, US

(73) Assignee: Pedscan Ltd.

(21) Appl. No.: 11/232,317

(22) Filed: Sep. 21, 2005

(51) Int. Cl. G06K 9/68

(52) U.S. Cl. 382/226

(57) ABSTRACT

Genetic family-tree object recognition is disclosed. In one embodiment, a method includes processing an image to identify a genetic object in the image and a connector associated with the genetic object; and associating at least one other object to the genetic object based on the connector. The method may be in a form of a machine-readable medium embodying a set of instructions that, when executed by a machine, cause the machine to perform the method. Processing the image (e.g. in real-time on drawing of the image in an input device) may include examining the image to determine if a particular pixel is associated with a geometric shape (e.g. a rectangle to represent a male individual and a circle to represent a female individual) by examining at least one characteristic of neighboring pixels to the particular pixel. An editable database library of various genetic objects may be referenced to identify the genetic object.

### FIELD OF TECHNOLOGY

This disclosure relates generally to the technical fields of genetics, in one example embodiment, to an apparatus and a method of genetic family-tree object recognition.

### BACKGROUND

A family-tree is a representation (e.g., a chart, a diagram, a table, etc.) that shows family (e.g., a domestic group of individuals, and/or a number of domestic groups affiliated by blood and/or by a variety of legal ties such as marriage, domestic partnership, adoption, surname, etc.) connections between individuals, including characteristics (e.g., names, dates of life, places of residence, occupations, etc.) of various individuals associated by indicators (e.g., lines, etc.) representing life events (e.g., marriages, extra-marital unions, progeniture, etc.).

Genealogy (e.g., a study of relationships between organisms) can be used to study and/or analyze a traditional family-tree (e.g., also referred to as a family pedigree). Genealogy has been practiced at least since the 16^{th} century (e.g., records of European persons were taken by governments to keep track of citizens), and there are archives (e.g., Burke's Peerage, Burke's Landed Gentry in the United Kingdom, etc.) of hand-drawn traditional family-trees in various libraries and institutions.

Generating the traditional family-tree may involve collecting names of relatives (e.g., both living and/or deceased), and establishing relationships based on evidence and/or documentation. Analyzing an archive of hand-drawn traditional family-trees requires thousands of labor hours to recreate hand-drawn data in electronic form. Redrawing the archive of traditional family-trees in electronic form is difficult because of the sheer volume of many archives (e.g., often spanning tens of thousands of individual hand-drawn traditional family-trees created over decades and/or centuries).

Genetic genealogy is the application of genetics (e.g., science of genes, heredity, and/or the variation of organisms) to genealogy. A deoxyribonucleic acid (DNA) is a nucleic acid that contains genetic instructions specifying a biological development of cellular forms of life (and/or many viruses). Genetic genealogy involves the use of genealogical DNA testing (e.g., examining nucleotides at specific locations on an individual's DNA) to determine the level of genetic relationship between different individuals (e.g., because the DNA's correlation with genetic propagation of inherited traits).

The practice of genetic genealogy may include a capture of genetic information from a patient by an administrator (e.g., a doctor and/or a genetic counselor). This information may be captured from the patient by hand (e.g., because the patient may feel uncomfortable when the administrator uses an electronic device to capture information). The administrator (e.g., a doctor and/or a genetic counselor) may hand-draw genetic information in a hand-drawn genetic family-tree (e.g., showing genetic variations of individuals). In order to share and/or analyze the hand-drawn genetic family-tree with other parties (e.g., a lab, other family members, a specialist, a genetic counselor, another doctor, etc.), the hand-drawn genetic family-tree can be converted into an electronic form by manual entry in an application program (e.g., ePedigree®, Progeny®, Cyrillic®, etc.).

Electronic devices (e.g., Logitech® Pen Devices) to render geometric shapes cannot appreciate a connection between various individuals (e.g., because a represented individual is associated with a connection line that extends from the represented individual to other individuals) in a hand-drawn family-tree (e.g., the traditional family-tree and the genetic family-tree). Manually redrawing of the hand-drawn family-tree is an expensive, time-consuming, and inefficient process because of the duplication of labor, likelihood of human error during the re-entry of data, and the sheer volume of archival data.

### SUMMARY

Genetic pedigree object recognition is disclosed. In one aspect, a method includes processing an image to identify a genetic object in the image and a connector associated with the genetic object; and associating at least one other object to the genetic object based on the connector. The connector may be coupled to the genetic object in a center of an edge of the genetic object. The image may be pre-formed in a stencil form prior to the processing the image.

Processing the image (e.g. in real-time on drawing of the image in an input device) may include examining the image to determine if a particular pixel is associated with a geometric shape (e.g. a rectangle to represent a male individual and a circle to represent a female individual) by examining at least one characteristic of neighboring pixels to the particular pixel. Identifying whether a particular pixel in the image is associated with a character may be based on an optical-character-recognition (OCR) algorithm.

While processing the image, an editable database library of various genetic objects may be referenced to identify the genetic object. In addition, a user preference database having parameter information may also be referenced. While identifying the genetic object and the connector, an error correction algorithm (e.g. an error correction algorithm that considers at least one of a fill-uniformity in a shape in the image, a linearity of the shape, a position of the shape, and a distance between the shape and the connector) having a threshold parameter may be applied automatically.

The association of the at least one other object to the genetic object may be used to create an electronically-searchable genetic family-tree, which may be aggregated and analyzed with other family-trees associated through a network, and output in any format including a markup format, a Visio file, an editable PDF file, a tab delimited format, and/or a database format.

In another aspect, a system includes comparing a genetic drawing with a database object; capturing at least one characteristic of the genetic drawing based on an identification data associated with the genetic drawing; and automatically associating the genetic drawing and the at least one characteristic with the database object. The identification data may be at least one of a shading of the genetic drawing, a text associated with the genetic drawing, and a shape associated with the genetic drawing.

Further, the system may include identifying at least one point on the genetic drawing that extends from the genetic drawing in a form of a connector and associates the genetic drawing to a different genetic drawing; and associating the database object with another database object representing the different genetic drawing based on the connector.

In yet another aspect, an apparatus includes a family-tree analysis module to determine that an object is related to at least one other object; and a rendering module to electronically capture the object, the at least one other object, and a relationship between the object and the at least one other object.

In addition, the apparatus may also include an optical-character-recognition (OCR) module to capture at least one characteristic associated with the object based on an identification data. The object may be in a hand-drawn document, and the apparatus may automatically scan and process a plurality of the hand-drawn documents using the family-tree analysis module and the rendering module. The various operations (e.g., methods) described herein may be in a form of a machine-readable medium embodying a set of instructions that, when executed by a machine, cause the machine to perform the method.

Other features will be apparent from the accompanying drawings and from the detailed description that follows.

### BRIEF DESCRIPTION OF THE DRAWINGS

Example embodiments of the present invention are illustrated by way of example and not limitation in the figures of the accompanying drawings, in which like references indicate similar elements and in which:

FIG. 1 is a block diagram of a recognition module to transform a hand-drawn family tree to an electronically modifiable family tree, according to one embodiment.

FIG. 2 is an exploded view of the recognition module associated with a geometry database and a reference table, according to one embodiment.

FIG. 3 is a table view of the geometry database, according to one embodiment.

FIG. 4 is a table view of the reference table, according to one embodiment.

FIG. 5 is an interaction view between the recognition module and various parties including a doctor, a lab, and a genetic counselor, according to one embodiment.

FIG. 6 is a diagrammatic representation of the recognition module associated with a data processing system capable of processing a set of instructions to perform any one or more of the methodologies herein, according to one embodiment.

FIG. 7 is a flow chart of processing an image to identify a genetic object in the image and a connector associated with the genetic object, according to one embodiment.

FIG. 8 is a flow chart of comparing a genetic drawing with a database object, according to one embodiment.

FIG. 9 is an apparatus view of a hardware device having a recognition circuit, according to one embodiment.

FIG. 10 is a graphical user interface view of the recognition module, according to one embodiment.

FIG. 11 is an exploded view of connectors in a hand-drawn family tree drawn on a stencil paper, according to one embodiment.

Other features of the present embodiments will be apparent from the accompanying drawings and from the detailed description that follows.

### DETAILED DESCRIPTION

Genetic family-tree object recognition is disclosed. In the following description, for purposes of explanation, numerous specific details are set forth in order to provide a thorough understanding of the various embodiments. It will be evident, however, to one skilled in the art that the various embodiments may be practiced without these specific details. An example embodiment provides methods and systems to process an image to identify a genetic object in the image and a connector associated with the genetic object. Example embodiments of a method and a system, as described below, may also be used to compare a genetic drawing with a database object. It will be appreciated that the various embodiments discussed herein may/may not be the same embodiment, and may be grouped into various other embodiments not explicitly disclosed herein.

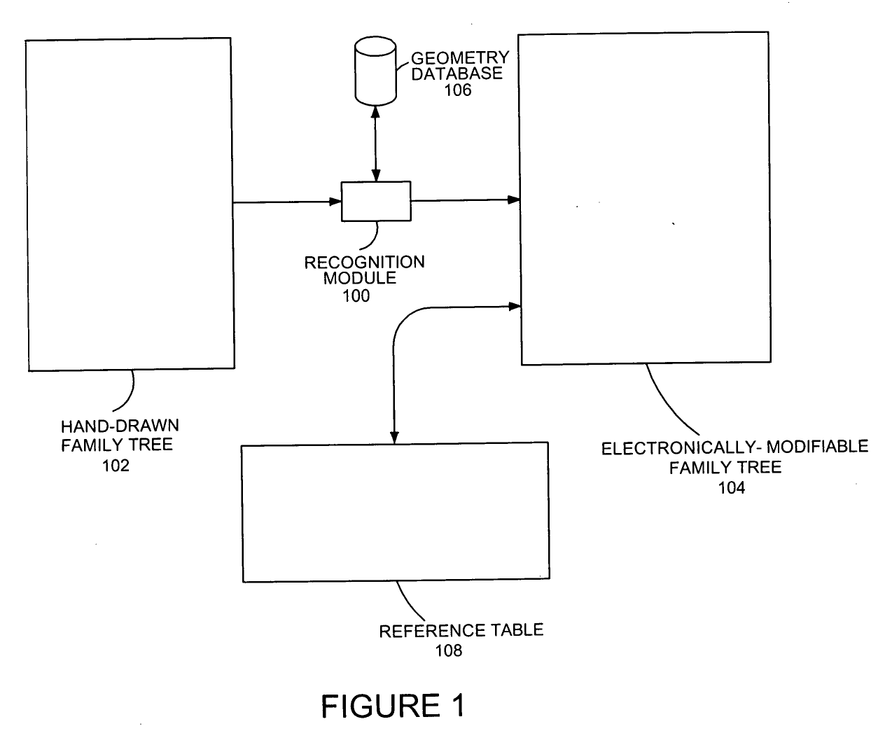

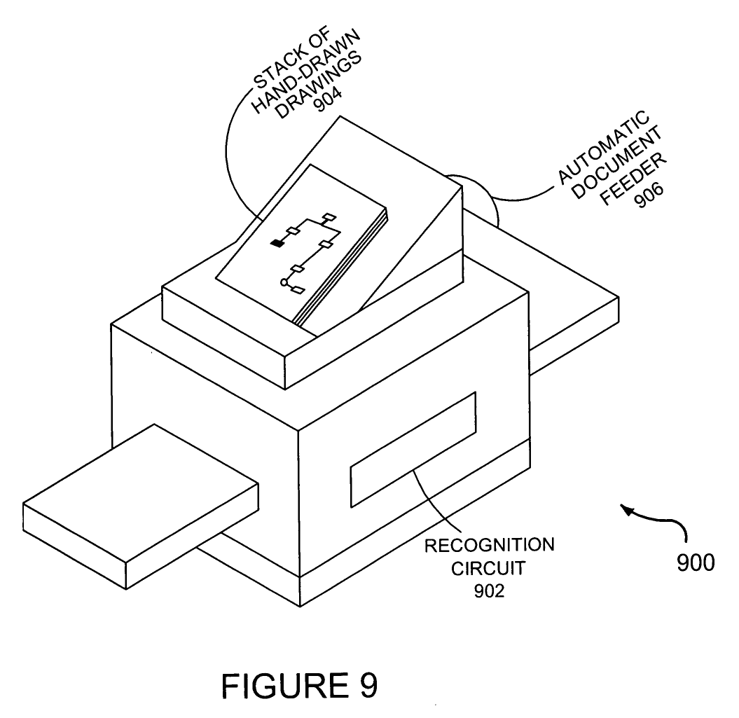

FIG. 1 is a block diagram of a recognition module 100 to transform a hand-drawn family tree 102 to an electronically-modifiable family tree 104, according to one embodiment. FIG. 1, a recognition module 100 processes (e.g., receives, analyzes, examines) the hand-drawn family tree 102 (e.g., a user may place the hand-drawn family tree 102 onto a hardware device 900 having a recognition circuit 902 as illustrated in FIG. 9). In one embodiment, the recognition module 100 processing occurs in real-time (e.g., while the user is presently drawing the hand-drawn family tree 102 on a pen device) on drawing of an image in an input device (e.g., the hardware device 900 of FIG. 9). In another embodiment, the hand-drawn family tree 102 (e.g., an image of a human ancestral genetic relationship) is pre-formed in a stencil form (e.g., a paper having a set of grid lines and/or associated rules to aid processing of the hand-drawn family tree 102 by the recognition module 100) prior to the processing the image.

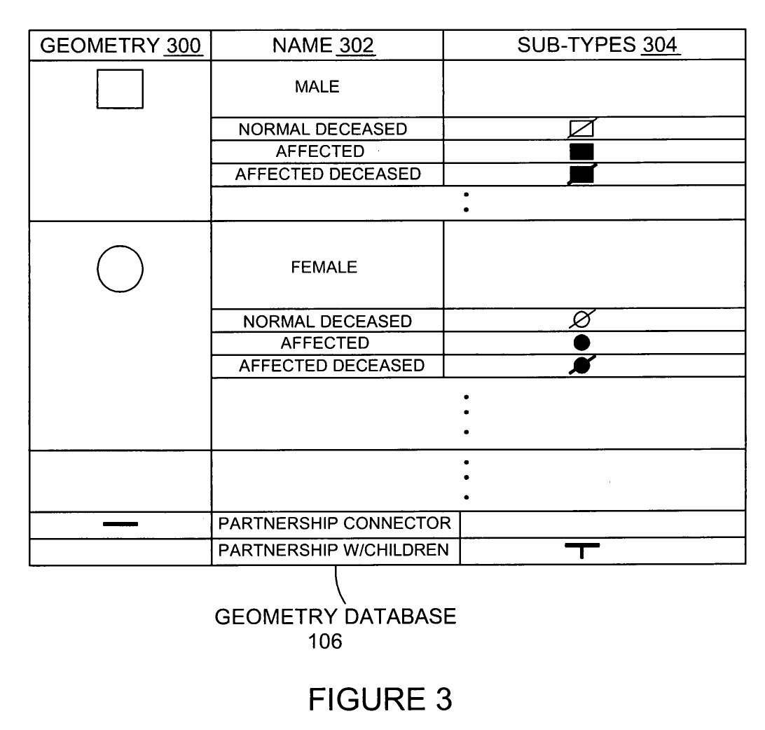

The recognition module 100 (e.g., the recognition module 100 may be created using software code and/or hardware circuitry) may consult a geometry database 106 (e.g., an directory of various shapes relevant to genetic genealogy as illustrated in the exploded view of the geometry database 106 in FIG. 3) to prepare the electronically modifiable family tree 104 (e.g., an electronically modifiable graphical representation of an arrangement and/or relationships between the various family members and their genetic conditions/states) and a reference table 108 (e.g., an editable directory of relationships between various family members that is used to create the electronically modifiable family tree 104).

In one embodiment, the electronically modifiable family tree 104 of FIG. 1 (e.g., an electronically-searchable genetic family-tree) is created by associating at least one other object to each genetic object represented in the electronically modifiable family tree 104. In another embodiment, the electronically-modifiable family-tree is output in any format including a markup format (e.g., a HTML file or a XML file), a Microsoft® Visio® file, an editable Adobe® PDF® file, a tab delimited format (e.g., or any other type of delimited text file), and a database format (e.g., directly into an Oracle® database).

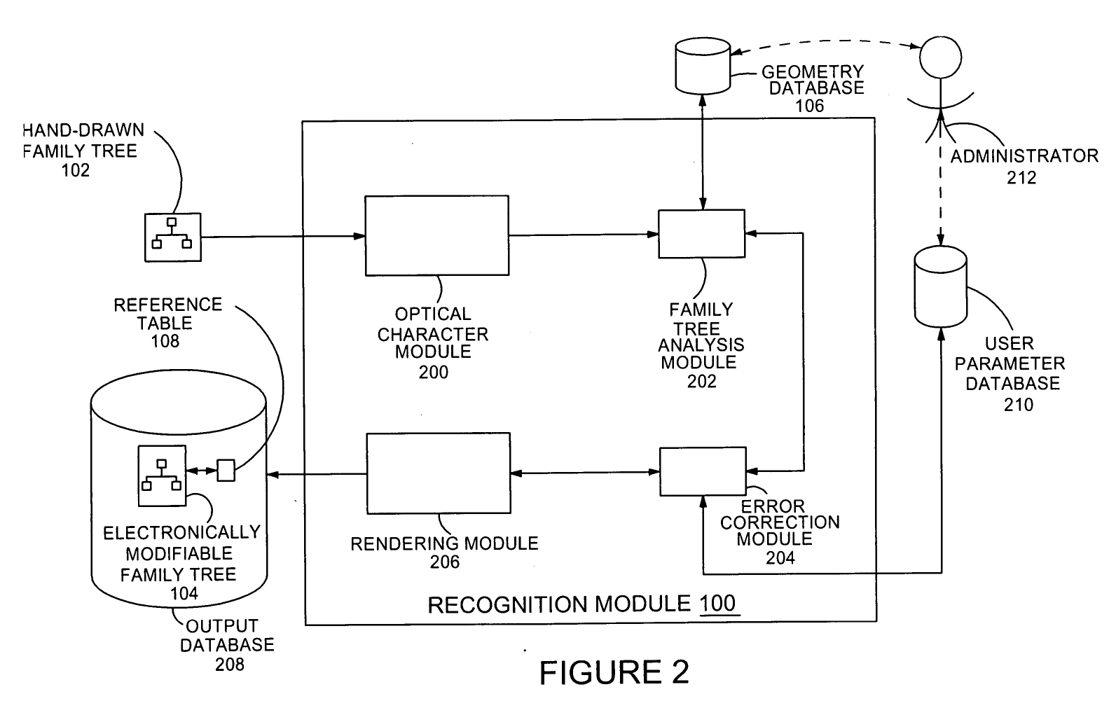

The recognition module 100 of FIG. 1 is best understood with reference to FIG. 2. FIG. 2 is an exploded view of the recognition module 100 associated with a geometry database 106 (e.g., an editable database library of various genetic objects to identify the genetic object) and the reference table 108, according to one embodiment. Specifically, FIG. 2 illustrates that the hand-drawn family tree 102 (e.g., a hand-drawn document) is received into an optical character (OCR) module 200 of the recognition module 100. The optical-character-recognition module 202 may capture (e.g., convert into a computer editable text) at least one characteristic (e.g., a handwritten text drawn next to a particular family member) associated with each object (e.g., a family member) based on an identification data (e.g., identification data indicating through lines or connectors that it is associated with a particular family member). After the optical character module 200 completes operations on the hand-drawn family tree 102, a family tree analysis module 202 processes the hand-drawn family tree 102.

In one embodiment, the family tree analysis module 202 may examine various identification data in the hand-drawn family tree 102 such a shading of each genetic drawing (e.g., to identify the genetic state of each family member), a text associated with the genetic drawing (e.g., text that has been converted into characters that are editable by the optical character recognition module 200), and a shape (e.g., a geometric shape that identifies whether an individual drawing identifies a male or a female) associated with the genetic drawing. In one embodiment, the family tree analysis module 202 identifies whether a particular pixel in the image (e.g., the hand-drawn family tree 102) is associated with a character (e.g., an English character) based on an optical-character-recognition (OCR) algorithm utilized by the optical character module 200. If the particular pixel is associated with the character, then the family tree analysis module 202 may ignore that particular pixel and focus on analyzing pixels to determine family members (e.g., objects) that are not text characters. In addition, the family tree analysis module 202 may store each character that has been identified in a database.

In one embodiment, the family-tree analysis module 202 may determine that an object is related to at least one other object (e.g., a particular drawing of a male on the hand-drawn family-tree 102 is married to another drawing of a female on the hand-drawn family-tree 102). The family tree analysis module 202 may consult the geometry database 106 (e.g., to determine whether an identified shape is associated with a shape in the geometry database 106). An administrator (e.g., a user) may enter parameter data into the geometry database 106.

Then, after and/or during the processing of the hand-drawn family tree 102 by the family tree analysis module 202, the error correction module 204 is utilized. The error correction module 204 may reference a user parameter database 210 (e.g., which may have parameter information that is entered by a user to identify a degree of tolerance for a fill in an image, etc.). In one embodiment, an error correction algorithm (e.g., an iterative algorithm) utilized by the error correction module 204 considers at least one of a fill-uniformity in a shape (e.g., how completely a user has filed in a particular shape element) in a family member, a linearity of the shape of the family member, a position of the shape, and/or a distance between the shape and a connector between different family members. In another embodiment, the connector is coupled to a genetic object representing a family member in a center of an edge of the genetic object.

The user parameter database 210 may also receive input from the administrator 212. The hand-drawn family tree 102 may be then transferred to a rendering module 206 as illustrated in FIG. 2. The rendering module 206 may create the electronically modifiable family tree 104 and the reference table 108. In one embodiment, the rendering module 206 may electronically capture each family member (e.g., each object on the hand-drawn family tree 102), at least one other family member, and a relationship between each family and other family members (e.g., by identifying at least one connector between each family member). The electronically modifiable family tree 104 and the reference table 108 may be stored in the output database 208.

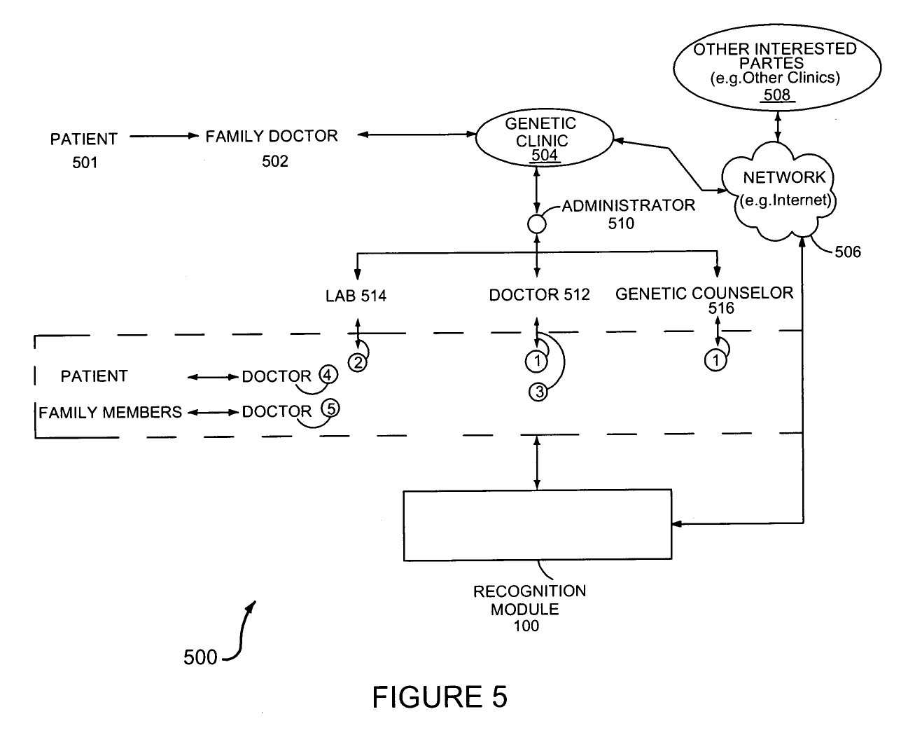

In one embodiment, the family tree analysis module 202 examines the hand-drawn family tree 102 to determine if a particular pixel is associated with a geometric shape (e.g., a geometric shape in the geometry database 106) by examining at least one characteristic of neighboring pixels to the particular pixel (e.g., a pixel in a scanned version of the hand-drawn family tree 102 that is analyzed by the optical character module 200 of FIG. 2). In one embodiment, the error correction module 204 automatically applies an error correction algorithm (e.g., an executable code) having a threshold parameter (e.g., a user definable tolerance for how much a shape has been filled, etc.) when identifying a genetic object (e.g., a family member) and/or a connector between one object and another object. In another embodiment, the electronically-modifiable family-tree 104 is aggregated and analyzed with other family-trees associated through a network (e.g., a network 506 as illustrated in FIG. 5).

FIG. 3 is a table view of the geometry database 106 of FIG. 1 (e.g., and as described in FIG. 2), according to one embodiment. The geometry database 106 may include three types of fields, a geometry field 300, a name field 302, and a sub-types field 304. For example, the geometry field 300 may include a rectangle with no fill pattern, which denotes a male, and a variety of states for a male. A normal deceased state of a male may be indicated with the rectangle having a diagonal line, as illustrated in FIG. 3. An affected male may be indicated with the rectangle having a filled interior as illustrated in FIG. 3. An affected and deceased male may be indicated with the rectangle having the filled interior and the diagonal line as illustrated in FIG. 3.

Similarly, as illustrated in FIG. 3, the geometry field 300 may include a circle with no fill pattern, which denotes a female, and a variety of states for a female. A normal deceased state of a female may be indicated with the circle having a diagonal line, as illustrated in FIG. 3. An affected female may be indicated with the circle having a filled interior as illustrated in FIG. 3. An affected and deceased female may be indicated with the circle having the filled interior and the diagonal line as illustrated in FIG. 3. Other types of the geometry field 300 may be present in the geometry database 106 of FIG. 3. For example, the geometry field 300 may include a partnership connector that may be a horizontal line of heightened thickness. A partnership with children may be indicated with a “T” shaped connector as illustrated in FIG. 3.

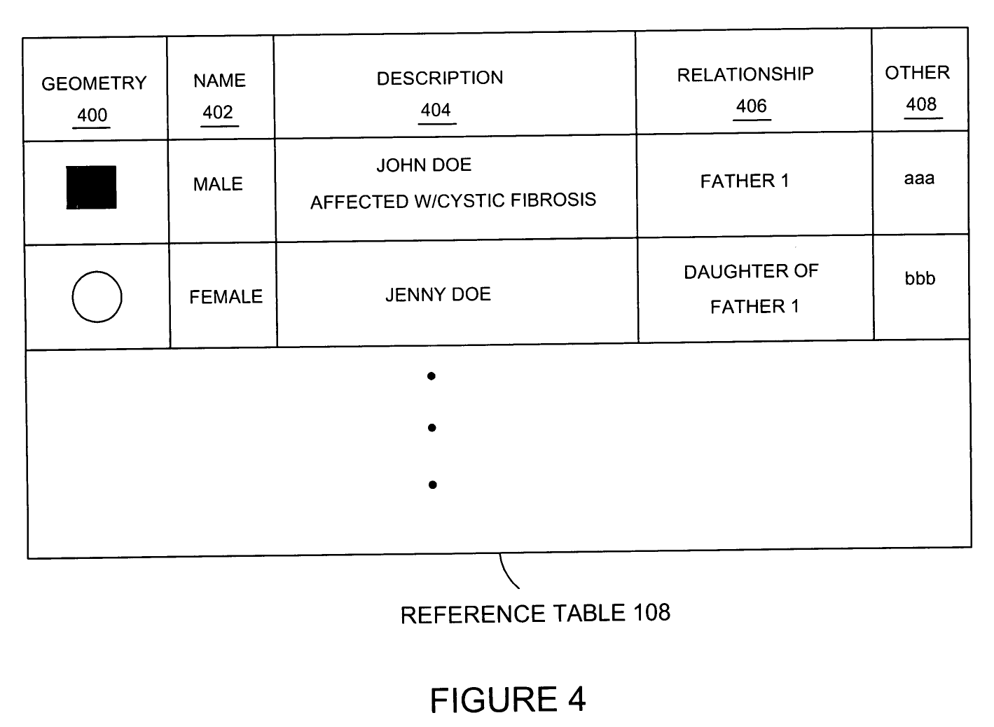

FIG. 4 is a table view of the reference table 108 as described in FIG. 1 and FIG. 2, according to one embodiment. The reference table 108 includes a geometry field 400, a name field 402, a description field 404, a relationship field 406, and an other field(s) 408. Particularly, there are two types of geometry fields illustrated in the reference table 108 of FIG. 4. An affected male (John Doe, affected w/cystic fibrosis) is illustrated in the description field 404, and a normal female is illustrated as Jenny Doe in FIG. 4. The geometry field 400 may reference the geometry field 300 as described of the geometry database 106 in one embodiment. The geometry field 300 and the geometry field 400 may include a shared index table in one embodiment, and may be the same in another embodiment.

The relationship field 406 illustrates the relationship between one family member and another. Particularly, in FIG. 4, Jenny Doe (the relationship field 406 for Jenny Doe having a value ‘Daughter of Father 1’) is illustrated as the daughter of John Doe (the relationship field 406 for John doe having a value ‘Father 1’). The other field(s) 408 may have any other data that might be useful to reference using the reference table 108.

FIG. 5 is an interaction view 500 between the recognition module 100 and various parties including a doctor 512 (e.g., a doctor specializing in genetics), a lab 514, and a genetic counselor 516, according to one embodiment. In FIG. 5, a patient 501 is illustrated as going to a family doctor 502. The family doctor 502 may speak with a genetic clinic 504. The genetic clinic 504 may be connected to other interested parties 508 (e.g., other clinics) through the network 506 (e.g., Internet). The genetic clinic 504 may work with an administrator 510 to communicate with the doctor 512, the lab 514, and the genetic counselor 516.

First, as illustrated in circled one (‘1’), the doctor 512 or the genetic counselor 516 may see the patient 501. Then, the lab 514, as illustrated in circled two (‘2’), may see the patient 501. Next, the doctor 512 may again see the patient 501 to go over results from the lab 514, as illustrated in circled three (‘3’). The patient 501 and doctor 512 may then confer, as illustrated in circled four (‘4’). Next, other family members may confer with the doctor 512, as illustrated in circled five (‘5’). All the data may be processed by the recognition module 100 (e.g., as described in detail in FIG. 2), and communicated between different parties (e.g., between the patient 501, the family doctor 502, the genetic clinic 504, the administrator 510, the doctor 512, the lab 514, the genetic counselor 516, and/or other interested parties 508) in FIG. 5 during various operations illustrated in FIG. 5 depending on medical treatment requirements and/or depending on laws of a particular jurisdiction in which the recognition module 100 is implemented.

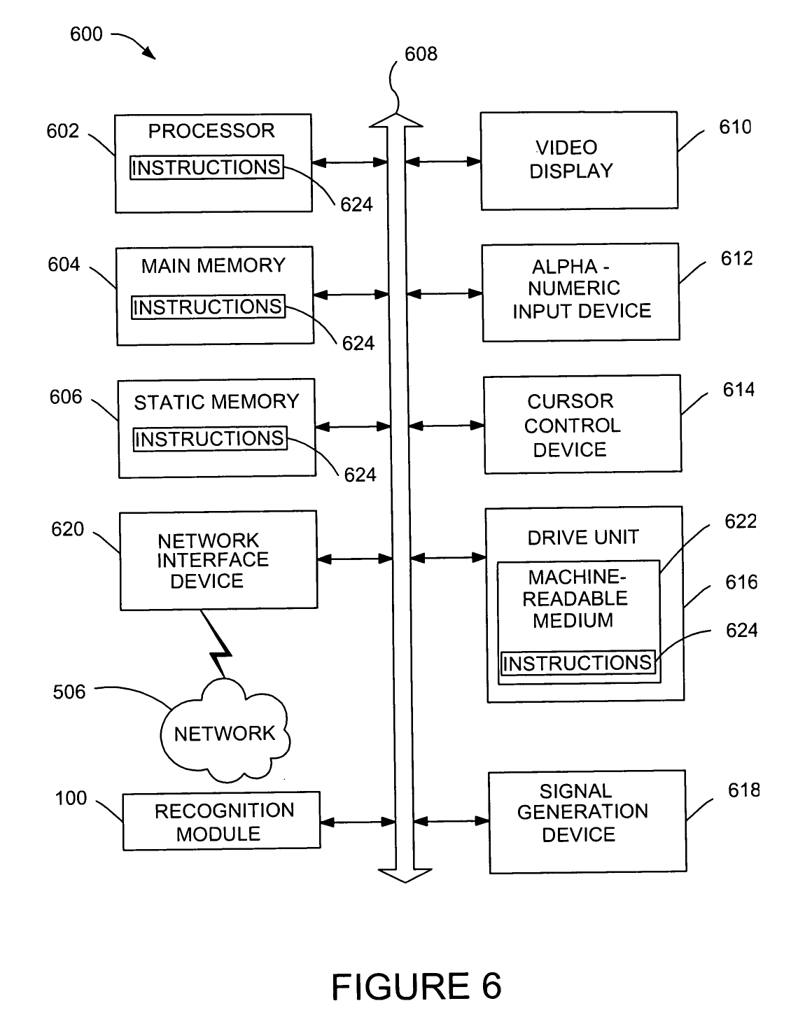

FIG. 6 is a diagrammatic representation of the recognition module 100 associated with a data processing system 600 capable of processing a set of instructions to perform any one or more of the methodologies herein, according to one embodiment. In various embodiments, the data processing system 600 operates as a standalone device and/or may be connected (e.g., networked through the network 506) to other machines. In a networked deployment, the data processing system 600 may operate in the capacity of a server and/or a client machine in server-client network environment, and/or as a peer machine in a peer-to-peer (or distributed) network environment. The data processing system 600 may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine.

Further, while only a single data processing system 600 is illustrated, the term “data processing system” shall also be taken to include any collection of machines that individually and/or jointly execute a set (or multiple sets) of instructions to perform any one and/or more of the methodologies discussed herein.

The example data processing system 600 includes the recognition module 100, a processor 602 (e.g., a central processing unit (CPU) a graphics processing unit (GPU) and/or both), a main memory 604 and a static memory 606, which communicate with each other via a bus 608. The data processing system 600 may further include a video display unit 610 (e.g., a liquid crystal display (LCD) and/or a cathode ray tube (CRT)). The data processing system 600 may also include an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions 624 (e.g., software) embodying any one or more of the methodologies and/or functions described herein. The instructions 624 may also reside, completely and/or at least partially, within the main memory 604, the static memory 606, the drive unit 616 and/or within the processor 602 during execution thereof by the data processing system 600, the main memory 604, the static memory 606, the drive unit 616 and the processor 602 also constituting machine-readable media.

The instructions 624 may further be transmitted and/or received over a network 626 via the network interface device 620. While the machine-readable medium 622 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

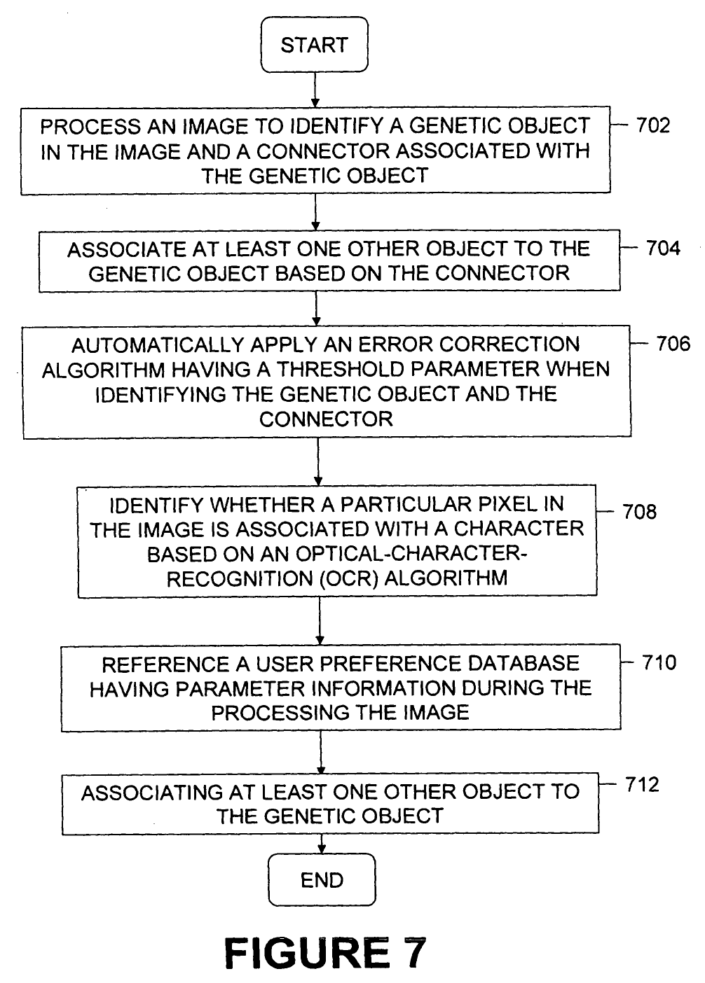

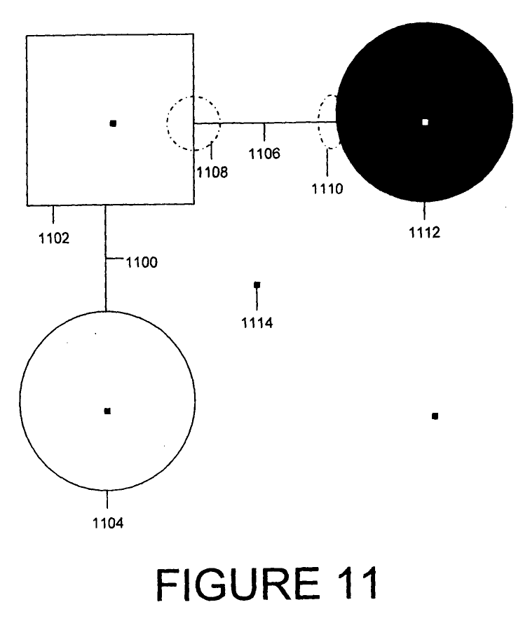

FIG. 7 is a flow chart of processing an image to identify a genetic object in the image and a connector (e.g., a connector 1100 and/or a connector 1106 as illustrated in FIG. 11) associated with the genetic object (e.g., a genetic object 1102 as illustrated in FIG. 11), according to one embodiment. In operation 702, an image (e.g., an image in the hand-drawn family tree 102) is processed (e.g., by referencing an editable database library of various genetic objects to identify the genetic object such as the geometry database 106 of FIG. 1) to identify a genetic object (e.g., a family member) in the image and a connector (e.g., a connector between different family members) associated with the genetic object. In one embodiment, the connector is coupled to the genetic object in a center of an edge of the genetic object (e.g., as illustrated in a region 1108 of FIG. 11).

When the genetic object is a circle (e.g., a genetic object 1112 as illustrated in FIG. 11), the connector may be connected at 90 degree intervals in the circle so as to form a semicircle above and below the connector if the connector is extended through the circle (e.g., as illustrated in a region 1110 of FIG. 11). In operation 704, at least one other object (e.g., another family member) is associated to the genetic object based on the connector (e.g., the genetic object 1102 is associated with a genetic object 1104 through the connector 1100 in FIG. 11). In one embodiment, the identification data is at least one of a shading of the genetic drawing (e.g., a genetic shape), a text associated with the genetic drawing, and a shape associated with the genetic drawing. In addition, in one embodiment, a stencil having any number of equally spaced dots (e.g., such as a dot 1114 and other dots illustrated on FIG. 11) can be used (e.g., to improve recognition by a hardware device 900 of FIG. 9) to enable a user to create a hand-drawn family tree (e.g., the hand-drawn family tree 102) directly on a paper having a pattern of the stencil (e.g., a stencil paper, as illustrated in FIG. 11).

In operation 706, an error correction algorithm (e.g., a mathematical algorithm to determine a degree of tolerance and uniformity of a shape when compared to a reference library) having a threshold parameter (e.g., set by a user using the user parameter database 210 as described in FIG. 2) is automatically applied. In one embodiment, the error correction algorithm considers at least one of a fill-uniformity in a shape in an image (e.g., a shape, a family member, etc.), a linearity of the shape, a position of the shape, and a distance between the shape and the connector.

Then, in operation 708, an identification is made (e.g., by a processor such as the processor 602 of FIG. 6) whether a particular pixel in the image is associated with a character based on an optical-character-recognition (OCR) algorithm (e.g., performed by the optical character module 200 of FIG. 2). Next, in operation 710, a user preference database is referenced having parameter information during the processing of the image (e.g., the user parameter database 210 as described in FIG. 2). In operation 712, at least one other object is associated to the genetic object (e.g., by using a connector from the geometry database 106 of FIG. 1).

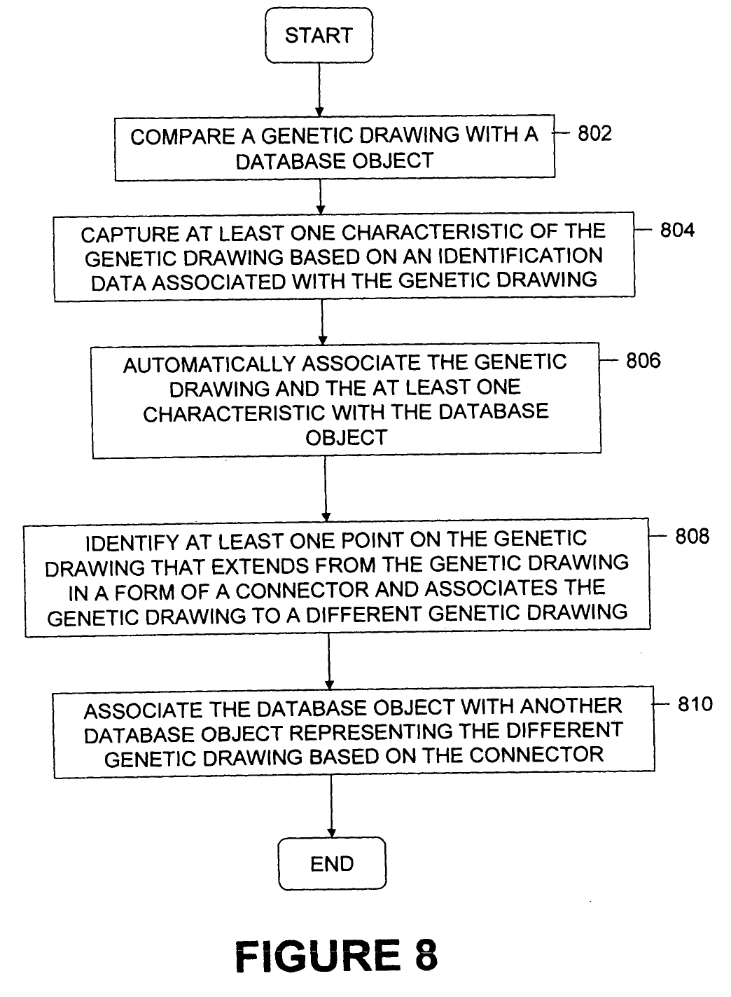

FIG. 8 is a flow chart of comparing a genetic drawing with a database object, according to one embodiment. In operation 802, a genetic drawing (e.g., a family member on the hand-drawn family tree 102 of FIG. 1) is compared with a database object (e.g., a database object in the geometry database 106 of FIG. 1). Then, in operation 804, at least one characteristic (e.g., an identifier associated with a particular drawing) of the genetic drawing is captured (e.g., by the optical character recognition module 200 or the family tree analysis module 202 of FIG. 2) based on an identification data (e.g., hand drawn text) associated with the genetic drawing.

Then, in operation 806, the genetic drawing and the at least one characteristic is automatically associated with the database object (e.g., a shape in the geometry database 106 of FIG. 1). In operation 808, at least one point on the genetic drawing is identified that extends from the genetic drawing in a form of a connector and associates the genetic drawing with a different genetic drawing (e.g., a family member is associated with another family member through a connector). In operation 810, the database object is associated with another database object representing the different genetic drawing based on the connector.

FIG. 9 is an apparatus view of a hardware device 900 having a recognition circuit 902, according to one embodiment. In one embodiment, the recognition circuit 902 may be the recognition module 100 as previously described in FIGS. 1-8. The hardware device 900 is illustrated as including a stack of hand-drawn drawings 904 that are input into an automatic document feeder 906. In one embodiment, the hardware device 900 automatically scans and processes any number of the hand-drawn documents (e.g., the stack of hand-drawn drawings 904) using the family-tree analysis module 200 and the rendering module 206 as described in FIG. 2.

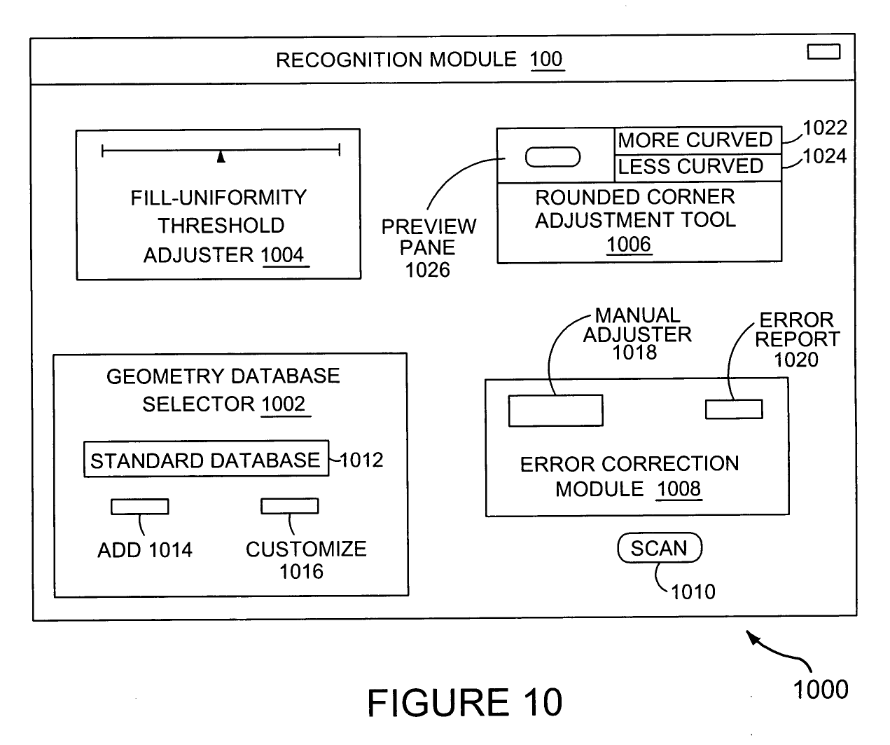

FIG. 10 is a graphical user interface view 1000 of the recognition module 100 (as described in FIGS. 1-9), according to one embodiment. The recognition module 100 includes a geometry database selector 1002, a fill uniformity threshold adjuster 1004, a rounded corner adjustment tool 1006, an error correction module 1008, and a scan button 1010. The geometry database selector 1002 includes a database type field 1012, an add selector 1014, and a customize selector 1016.

The fill-uniformity threshold adjuster 1004 may be adjusted to alter a fill uniformity. The rounded corner adjustment tool 1006 may include a preview pane 1026, a more curved adjuster 1022, and/or a less curved adjuster 1024. The error correction module 1008 includes a manual adjuster 1018 and an error report 1020. The scan button 1010 may be used to begin scanning on a hardware device (e.g., the hardware device 900 as illustrated in FIG. 9).

FIG. 11 is an exploded view of connectors (e.g., the connector 1100 and the connector 1106) in a hand-drawn family tree (e.g., the hand drawn family tree 102 of FIG. 1) drawn on a stencil paper, according to one embodiment. In FIG. 11, the genetic object 1102 is connected to the genetic object 1104 through the connector 1100. The genetic object 1102 is connected to the genetic object 1112 through the connector 1106. A series of dots (e.g., the dot 1104) for a stencil pattern to aid a user to draw the hand-drawn family tree, and to enable the recognition module 100 of FIG. 1 to capture a higher accuracy of details in the hand-drawn family tree. The region 1108 illustrates that the connector 1106 is connected to the genetic object 1102 at in the center of an edge of the genetic object 1102. In one embodiment, every genetic object is connected at the center of an edge with a connector. When the genetic object is a circle (e.g., the genetic object 1112), as illustrated in region 1110, the connector may be connected at one point at an edge of the circle, and other connectors may be connected at right angles (e.g., 90 degree angles) from each line forming the connector associated with the genetic object (e.g., the genetic object 1112).

Although the present embodiments has been described with reference to specific example embodiments, it will be evident that various modifications and changes may be made to these embodiments without departing from the broader spirit and scope of the invention. For example, the various modules, analyzers, generators, etc. described herein may be performed and created using hardware circuitry (e.g., CMOS based logic circuitry), firmware, software and/or any combination of hardware, firmware, and/or software (e.g., embodied in a machine readable medium).

For example, the recognition module 100, the optical character module 200, the family tree analysis module 202, the error-correction module 204, and/or the rendering module 206 may be embodied using transistors, logic gates, and electrical circuits (e.g., application specific integrated ASIC circuitry) using a recognition circuit 902, an optical character circuit, a family tree analysis circuit, an error-correction circuit, and/or a rendering circuit. In addition, it will be appreciated that the various operations, processes, and methods disclosed herein may be embodied in a machine-readable medium and/or a machine accessible medium compatible with a data processing system (e.g., a computer system). Accordingly, the specification and drawings are to be regarded in an illustrative rather than a restrictive sense.

What is claimed is:

1. A method, comprising:
processing an image to identify a genetic object in the image and a connector associated with the genetic object; and
associating at least one other object to the genetic object based on the connector.

2. The method of claim 1 wherein the processing the image further comprises examining the image to determine if a particular pixel is associated with a geometric shape by examining at least one characteristic of neighboring pixels to the particular pixel.

3. The method of claim 2 wherein the geometric shape is a rectangle to represent a male individual and a circle to represent a female individual.

4. The method of claim 1 wherein the processing the image further comprises automatically applying an error correction algorithm having a threshold parameter when identifying the genetic object and the connector.

5. The method of claim 4 wherein the error correction algorithm considers at least one of a fill-uniformity in a shape in the image, a linearity of the shape, a position of the shape, and a distance between the shape and the connector.

6. The method of claim 1 wherein the connector is coupled to the genetic object in a center of an edge of the genetic object.

7. The method of claim 1 further comprising identifying whether a particular pixel in the image is associated with a character based on an optical-character-recognition (OCR) algorithm.

8. The method of claim 1 wherein the processing the image references an editable database library of various genetic objects to identify the genetic object.

9. The method of claim 8 further comprising referencing a user preference database having parameter information during the processing the image.

10. The method of claim 10 wherein the processing occurs in real-time on drawing of the image in an input device.

11. The method of claim 1 wherein an electronically-searchable genetic family-tree is created based on the associating at least one other object to the genetic object.

12. The method of claim 11 wherein the electronically-searchable genetic family-tree is output in any format including one or more of a markup format, a Visio file, an editable PDF file, a tab delimited format, and a database format.

13. The method of claim 11 wherein the electronically-searchable genetic family-tree is aggregated and analyzed with other family-trees associated through a network.

14. The method of claim 1 wherein the image is pre-formed in a stencil form prior to the processing the image.

15. The method of claim 1 in a form of a machine-readable medium embodying a set of instructions that, when executed by a machine, cause the machine to perform the method of claim 1.

16. A system comprising:
means for comparing a genetic drawing with a database object;
means for capturing at least one characteristic of the genetic drawing based on an identification data associated with the genetic drawing; and
means for automatically associating the genetic drawing and the at least one characteristic with the database object.

17. The method of claim 16 wherein the identification data comprises at least one of a shading of the genetic drawing, a text associated with the genetic drawing, and a shape associated with the genetic drawing.

18. The method of claim 16 further comprising
means for identifying at least one point on the genetic drawing that extends from the genetic drawing in a form of a connector and associates the genetic drawing to a different genetic drawing; and
means for associating the database object with another database object representing the different genetic drawing based on the connector.

19. An apparatus comprising:
a family-tree analysis module to determine that an object is related to at least one other object; and
a rendering module to electronically capture the object, the at least one other object, and a relationship between the object and the at least one other object.

20. The apparatus of claim 19 further comprising an optical-character-recognition (OCR) module to capture at least one characteristic associated with the object based on an identification data, wherein the object is in a hand-drawn document, and wherein the apparatus automatically scans and processes a plurality of the hand-drawn documents using the family-tree analysis module and the rendering module.
